(19) United States
(12) Patent Application Publication
(10) Pub. No.: US 2008/0171798 A1
(43) Pub. Date: Jul. 17, 2008

(54) Benzimidazole-Substituted Polybezimidazoles as Initial Material For Producing Proton-Conducting Membranes

(76) Inventors: Dmitry Yurevich Likhachev, Moscow (RU); Aleksei Yurevich Leikin, Moscow (RU); Alexandr Lvovich Rusanov, Moscow (RU)

Correspondence Address: Limited Liability Company 'United Research and;Development Centre', Leninsky pr-t, 55/1-2, Moscow, 119333, omitted

(21) Appl. No.: 11/795,613

(22) PCT Filed: Jan. 19, 2006
(86) PCT No.: PCT/RU06/00012

§ 371 Date: Jul. 19, 2007

(30) Foreign Application Priority Data
Jan. 20, 2005 (RU) 2005101117

(51) Int. Cl. B01J 39/18

(52) U.S. Cl. 521/27

(57) ABSTRACT

The invention relates to application of benzimidazole-substituted polybenizimidazole polymers as initial material for preparing proton-conductive membranes, preferably used in high-temperature fuel cells. Detail methods are provided, comprising the steps of obtaining the polymers, preparing film containing the polymer, doping the film with predetermined acid, thereby forming a proton-conductive membrane with improved proton conductivity. Particularly, a group consisting of three types of the polymers is described. In a preferred embodiment, the predetermined acid is being phosphoric acid.

### CROSS-REFERENCE TO RELATED APPLICATIONS

This application is a U.S. national phase application of a PCT application PCT/RU2006/000012 filed on 19 Jan. 2006, published as WO2006078193, whose disclosure is incorporated herein in its entirety by reference, which PCT application claims priority of a Russian Federation patent application RU2005/101117 filed on 20 Jan. 2005.

### FIELD OF THE INVENTION

The present invention relates to materials for production of proton-conducting membranes, specifically for membranes of high-temperature fuel cells, and in particular it relates to application of benzimidazole-substituted polybenzimidazoles as initial material for preparing the above-mentioned membranes. This invention can be used for preparing proton-conductive membranes, in particular membranes for high-temperature fuel cells.

### BACKGROUND OF THE INVENTION

Currently polymer proton-conducting membranes are widely used for fuel cells with solid polymer electrolyte, where such membranes are exposed to long-term operation under high temperatures in the presence of oxidizers and other aggressive reagents. In relation to this, certain main requirements are imposed upon material for high-temperature membrane, such as thermal resistance, chemical stability, and possession of a set of satisfactory mechanical properties, ensuring reliable operation of membranes under elevated temperatures.

Recent efforts of developers of materials for proton-conducting membranes for high-temperature fuel cells have been focused on application of basic polymers complexes with strong acids. Thus there is an application known of polybenzimidazole as initial material, which is doped with phosphoric acid and is used for producing proton-conducting membranes for high-temperature fuel cells (J-T. Wang, J. S. Wainright, R. F. Savinell, M. Litt., Electrochim. Acta, v. 41, p. 193-197, (1996); J. A. Asensio, S. Borros, J. Polym. Sci., A 40, p. 3703-3710, (2002)).

There is a known application of such polymer as poly [2,2′-(m-phenylene)-5,5′-bibenzimidazole] with the following formula for preparing proton-conducting membranes:

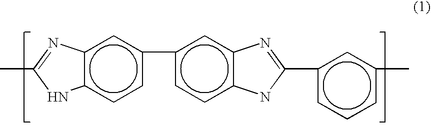

The value of proton conductivity of a polymer structured according to formula (1), doped with phosphoric acid, reaches 5×10⁻³ S/cm (X. Glipa, B. Bonnet., J. Mater. Chem., v. 9, p. 3045-3049, (1999)).

The main disadvantage of applications of the known materials as proton-conducting membranes is their insufficient proton conductivity. Conductivity of the doped systems is determined mainly by content of the dopant, in particular phosphoric acid, in a polymer matrix. Previously there have been attempts made to increase a level of acid adsorption by the polymers through introduction of fragments with high basicity, e.g., pyridine rings into constitutional units of the polymer (CUP) (described in an International Application publication WO 2004024796).

However, polybenzimidazoles based on 3,3′-diaminobenzidine and pyridine dicarboxylic acids are soluble in phosphoric acid of medium concentration (40-50%). To remove this disadvantage one has to introduce into the constitutional units of the polymer certain fragments (e. g., p-phenylene), which significantly reduce its solubility and hence the ability to process it into a film.

There are known benzimidazole-substituted polybenzimidazoles (i.e. polybenzimidazoles containing lateral benzimidazole substituents) based on bis-benzoylenebenzimidazoles, used as thermally resistant anti-adhesion coatings for heating elements (A. P. Travnikova, PhD in Chemistry Thesis, INEOS RAS, 1973).

### BRIEF DESCRIPTION OF THE INVENTION

The present invention is intended to solve the aforementioned problem, and increase the proton conductivity of proton-conductive membranes. This problem is solved by the use of of benzimidazole-substituted polybenzimidazoles as initial material for preparing proton-conducting membranes.

The proposed polymers with branched structure much more intensively absorb acid versus linear polymers described in formula (1), and that ensures an increase in proton conductivity of the membrane and extends its lifetime.

According to the invention claimed, it is proposed to use complexes of similar polymers with mineral or organic acids, phosphoric acid in particular, for producing proton-conductive membranes.

In a particular preferred embodiment of the invention implementation, benzimidazole-substituted polybenzimidazoles are selected from the group consisting of comprising poly-2,2′-[dibenzimidazole-2-yl-benzene]bibenzimidazole, poly-2,2′-[dibenzimidazole -2-yl-diphenyloxide]bibenzimidazole, poly-2,2′-[dibenzimidazole -2-yl-diphenyloxide]-oxy-bibenzimidazole.

### PREFERRED EMBODIMENTS AND BEST MODE OF THE INVENTION

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

Benzimidazole-substituted polybenizimidazoles, application of which is proposed in this invention, can be represented by various structures, such as poly-2,2′-[dibenzimidazole-2-yl-benzene]bibenzimidazole of formula (2), poly-2,2′-[dibenzimidazole-2-yl-diphenyloxide]bibenzimidazole of formula (3), poly-2,2′-[dibenzimidazole -2-yl-diphenyloxid]-oxy-bibenzimidazole of formula (4), which are prepared according to the following schemes of synthesis:

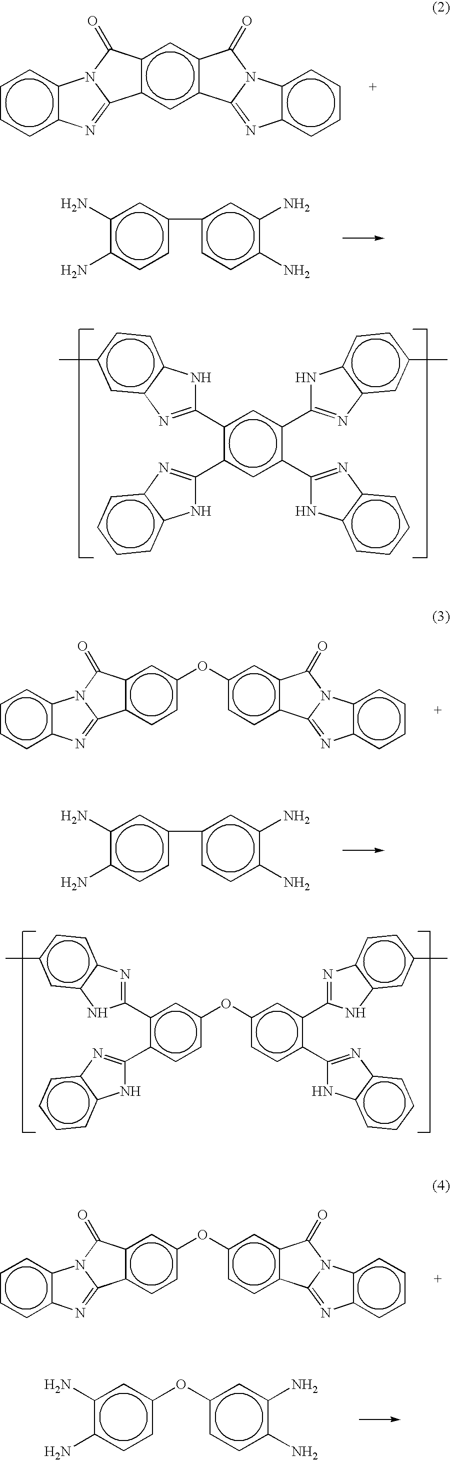

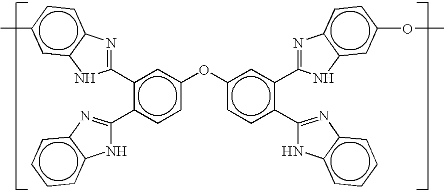

Table 1 below shows comparative assessment of the phosphoric acid absorption level, which indicates that polymers with the above branched structure, according to formulas (2)-(4), much more intensively absorb the acid versus linear polymers according to formula (1).

TABLE 1
Absorption of phosphoric acid by substituted polybenzimidazoles
of various structures at doping with 50% H₃PO₄

| | Concentration of H₃PO₄ | Mole of H₃PO₄/ |
|---|---|---|
| Polymer | in membrane, % | mole of CUP |
| 1 | 23 | 1.5 |
| 2 | 24 | 2.7 |
| 3 | 28 | 4.3 |
| 4 | 30 | 5.1 |

Table 2 below illustrates an increase in proton conductivity of the proposed polymers with branched structure, according to formulas (2)-(4), versus linear polymers according to formula (1).

TABLE 2
Proton conductivity of membranes based on substituted
polybenzimidazoles of various structures

| | | Proton |
|---|---|---|
| | Mole of H₃PO₄/ | conductivity, S/cm |
| Polymer | mole of CUP | (20° C.) |
| 1 | 1.,5 | 4.8 × 10⁻³ |
| 2 | 2.7 | 5.9 × 10⁻³ |
| 3 | 4.3 | 8.6 × 10⁻³ |
| 4 | 5.1 | 9.0 × 10⁻³ |

The preferred embodiments of the inventive method for producing proton-conductive membranes are disclosed herein below through the following specific examples.

### EXAMPLE 1

### Synthesis of oxy-bis-benzoylenbenzimidazole

Oxy-bis-benzoylenbenzimidazole is produced according to the following reaction:

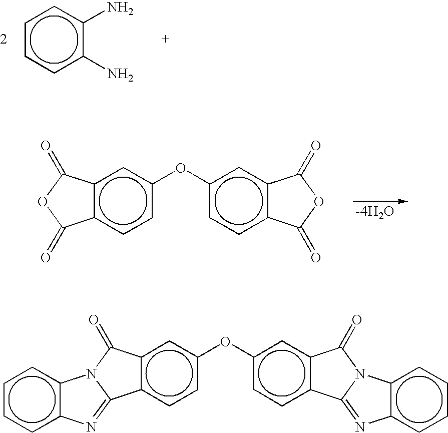

6.96 g of o-phenylenediamine are dissolved in 25 ml of nitrobenzene and suspension of 10 g of oxyi-diphthalic anhydride in nitrobenzene is poured to the solution obtained. The reaction mass is agitated under room temperature during 2 hours and then refluxed with water separation for 7 hours. The solution obtained is kept over night; then resulting sediment is filtered, washed on filter with nitrobenzene two times and with ether 2 times, and then dried to constant mass at 80° C. and 0.1 mm Hg. Yield of the target product is −7.9 g (54% of theoretically possible).

### EXAMPLE 2

### Synthesis of bis-benzoylenbenzimidazole

Bis-benzoylenbenzimidazole is prepared by the procedure similar to Example 1, from 10 g of pyromellitic anhydride and 9.9 g of o- phenylenediamine producing 10 g of the target product (60% of theoretically possible).

### EXAMPLE 3

### Preparing the Polymer According to Formula (2)

Charges of bis-benzoylenbenzimidazole (3 g), 3,3′- diaminobenzidine (1.7734 g) and 85% polyphosphoric acid (60 g) are placed into a two-neck flask with agitator. The flask is purged with argon for 30 minutes, then the temperature of the reaction mass is increased up to 200° C., and the reaction is carried out in a flow of argon during 10 hours. The hot reaction mass is poured into water, the polymer obtained is washed with water and kept in aqueous ammonia (pH=10) during 5 hours to neutralize the residual phosphoric acid. The neutralized polymer is washed with water and dried at 200° C. to a constant mass with production of 4.3 g of polymer (96% of theoretically possible).

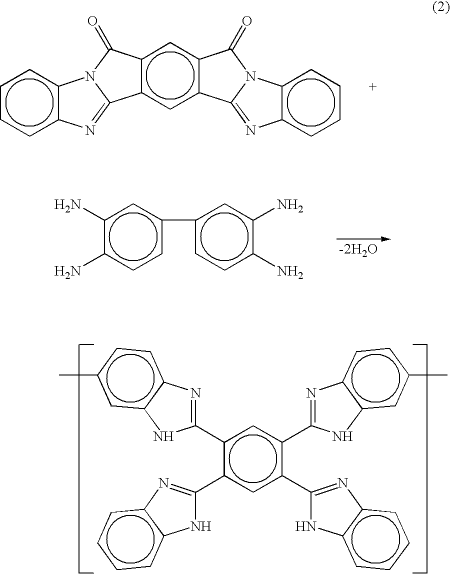

### EXAMPLE 4

### Preparing the Polymer According to Formula (3)

Synthesis of the polymer of formula (3) is carried out according to the procedure of Example 3 from oxy-bis-benzoylenbenzimidazole (2 g) and 3,3′-diaminobenzidine (0.9427 g).

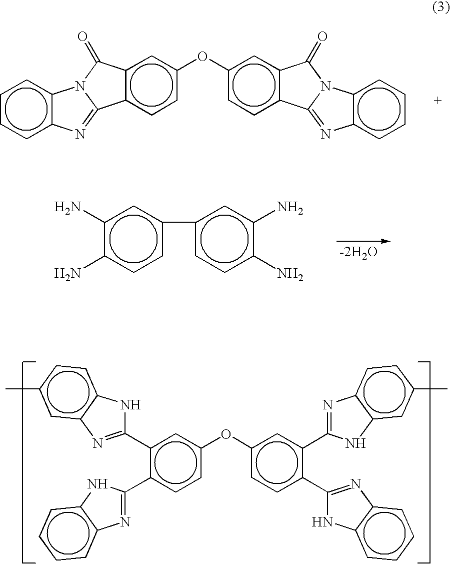

2.7 g of polymer are produced (97% of theoretically possible).

### EXAMPLE 5

### Preparing the Polymer According to Formula (4)

Polymer according to formula (4) is prepared by utilizing a procedure similar to the one described in Example 3 from oxy-bis-benzoylenbenzimidazole (2 g) and 3,3′,4,4′-tetraminodiphenyloxide (1.0132 g).

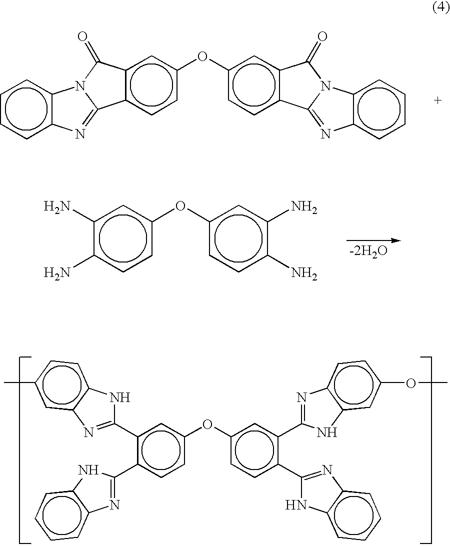

2.7 g of polymer are produced (95% of theoretically possible).

### EXAMPLE 6

### Casting Polymer Films

First, polymer charge is dissolved in a 3% solution of lithium chloride in dimethylacetamide at heating. The solution obtained is filtered through a glass filter, evenly spread over glass substrate and dried first in air until it becomes hazy, and then at a gradual increase of temperature from 50 up to 200° C. during 1 hour. The resultant film is removed from the substrate in a flow of water, washed with warm water to remove lithium chloride (3 times for 30 minutes) and dried at 200° C. to a constant mass.

### EXAMPLE 7

### Preparing Proton-Conductive Membranes by Doping

First, a polymer film is placed for 24 hours into a water solution containing 50% of phosphoric acid. Then the obtained film is dried with filter paper until no moisture is present on the surface, and then dried under vacuum (0.1 mm Hg) over P₂0₅ during 1 hour.

1. A method of new use of a benzimidazole-substituted polybenzimidazole polymer as initial material for preparing proton-conducting membranes comprising the steps of:
a) preparing a film containing said polymer; and
b) doping said film with phosphoric acid.

2. The method of new use according to claim 1, wherein said polymer being selected from the group consisting of
(A) poly-2,2′-[dibenzimidazole-2-yl-benzene]bibenzimidazole,
(B) poly-2,2′-[dibenzimidazole-2-yl-diphenyloxide]bibenzimidazole, and
(C) poly-2,2′-[dibenzimidazole-2-yl-diphenyloxid]-oxy-bibenzimidazole.

3. A method for production of proton-conductive membranes comprising:
a) a step for providing a benzimidazole-substituted polybenizimidazole polymer;
b) a step for preparing a film containing said polymer; and
c) a step for doping said film with predetermined acid thereby forming a proton-conductive membrane with improved proton conductivity.

4. The method according to claim 3, wherein
said predetermined acid being phosphoric acid.

5. The method according to claim 3, wherein said polymer being selected from the group consisting of
(A) poly-2,2′-[dibenzimidazole-2-yl-benzene]bibenzimidazole,
(B) poly-2,2′-[dibenzimidazole-2-yl-diphenyloxide]bibenzimidazole, and
(C) poly-2,2′-[dibenzimidazole-2-yl-diphenyloxid]-oxy-bibenzimidazole.

6. The method according to claim 4, wherein said polymer being selected from the group consisting of
(A) poly-2,2′-[dibenzimidazole-2-yl-benzene]bibenzimidazole,
(B) poly-2,2′-[dibenzimidazole-2-yl-diphenyloxide]bibenzimidazole, and
(C) poly-2,2′-[dibenzimidazole-2-yl-diphenyloxid]-oxy-bibenzimidazole.
